(19) United States
(12) Patent Application Publication
(10) Pub. No.: US 2016/0144788 A1
(43) Pub. Date: May 26, 2016

(54) Apparatuses, Systems, and Methods for Capturing and Reporting Vehicle Information

(71) Applicant: Southern Electronics Supply, Inc., New Orleans, LA (US)

(72) Inventors: Ignace A. Perrin, III, New Orleans, LA (US); Jack N. Cali, III, Prairieville, LA (US)

(73) Assignee: Southern Electronics Supply, Inc., New Orleans, LA (US)

(21) Appl. No.: 14/951,058

(22) Filed: Nov. 24, 2015

Related U.S. Application Data
(60) Provisional application No. 62/085,207, filed on Nov. 26, 2014.

(51) Int. Cl. B60R 1/00; H04N 5/247; G06K 9/00; H04N 5/44; B60R 11/04

(52) U.S. Cl. CPC B60R 1/00; H04N 5/44; B60R 11/04; G06K 9/00791; G06K 9/00771; G06K 9/00744; H04N 5/247

(57) ABSTRACT

Embodiments of the present disclosure include methods, apparatuses, and systems for capturing and reporting vehicle information. Embodiments include a school bus camera system having at least one camera and a video monitoring computer mounted on a school bus. Video monitoring computer may include a processor and a data connection. At least one camera may capture a continuous image set. Processor may be connected to the at least one camera and execute software. Software may select a first image subset from the continuous image set. First image subset may include images captured while a stopping alert is activated. Software may select a reference frame from the first image subset and a second image subset from the first image subset. Second image subset may include images where an object moves past the reference frame. Software may transmit the second image subset through the data connection.

This application claims the benefit of U.S. Provisional Patent Application No. 62/085,207, filed on Nov. 26, 2014, which is incorporated herein by reference.

### DESCRIPTION OF THE DRAWINGS

FIG. 1 is a schematic of a school bus camera system, according to an exemplary embodiment of the present disclosure.

FIG. 2 is a side and top view of a school bus with a camera system, according to an exemplary embodiment of the present disclosure.

FIG. 3 is a top view of the camera system shown in FIG. 2 with various directional views of cameras on the school bus.

FIG. 4 is an illustration of a reference frame of a school bus camera system, according to an exemplary embodiment of the present disclosure.

FIG. 5 is a schematic of reference frames of a school bus camera system, according to an exemplary embodiment of the present disclosure.

FIG. 6 is a front view of an enclosure of a school bus camera system, according to an exemplary embodiment of the present disclosure.

FIG. 7 is an isometric view of a video monitoring computer of a school bus camera system, according to an exemplary embodiment of the present disclosure.

FIG. 8 is an isometric view of an interior of the video monitoring computer shown in FIG. 7.

FIG. 9 a flowchart for a school bus camera system, according to an exemplary embodiment of the present disclosure.

### DESCRIPTION OF EMBODIMENTS

Many school buses in the United States include flashing warning lights and a stopping arm that extends from the bus when loading and unloading passengers. The stopping arm typically includes a stop sign that notifies drivers to stop and not pass the bus. While citations may be issued against drivers who fail to stop, it is generally difficult to enforce such laws. The expense of monitoring buses with police officers is often prohibitively expensive. To address this issue, video systems have been placed on buses that record vehicles that illegally pass an extended stopping arm.

Existing video systems have several issues. For example, video systems such as those disclosed in U.S. Pat. No. 5,382,953 often use simple video motion detection and may capture unnecessary and lengthy video that, because of the size of the data captured, may be difficult to efficiently process and analyze. These systems often require personnel to watch extended lengths of recorded video streams that are not relevant and/or related to any passing violations. Further, these large and lengthy video streams may make wireless file transfer difficult and sometimes impossible. Alternatively, dispatching persons to manually collect the video data from a storage unit located on a bus may also be time consuming and burdensome.

To address these problems, efforts have been made to reduce recording lengths/file size of these video streams. Existing systems may capture and record or transmit live video monitored by many, sometimes hundreds, of people who observe potential violations and mark the event on the video stream using software. Not only are these systems extremely cumbersome and inefficient, they are expensive and often do not capture all violations because of human error. These systems are also often problematic as video recording may be activated by, e.g., tree branches or other false alerts.

Embodiments of the present disclosure relate to apparatuses, systems, and methods for capturing, processing, analyzing and reporting vehicle information, and in particular though non-limiting embodiments, to apparatuses, systems, and methods for detecting school bus passing violations using video analytics.

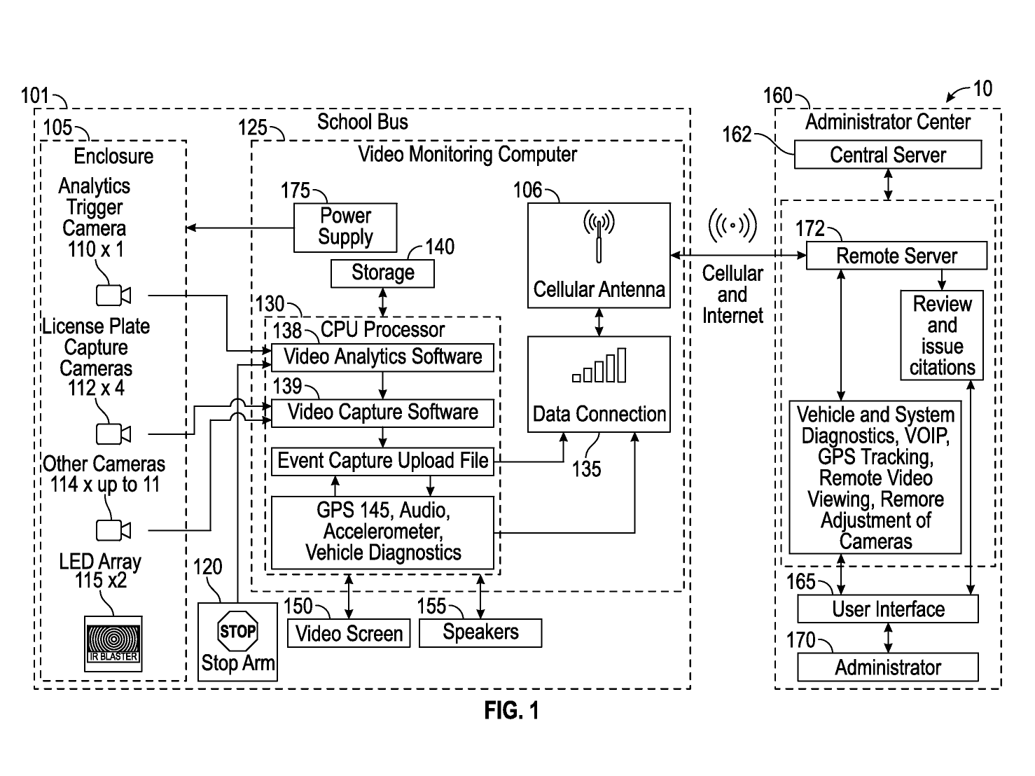

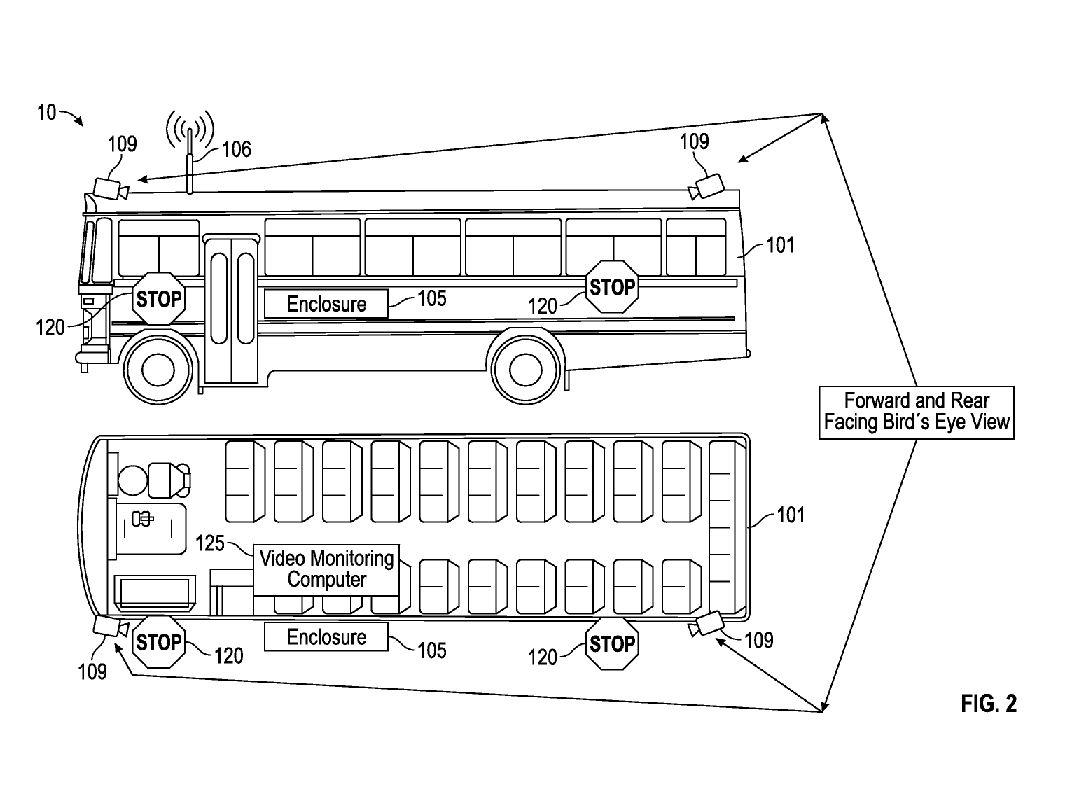

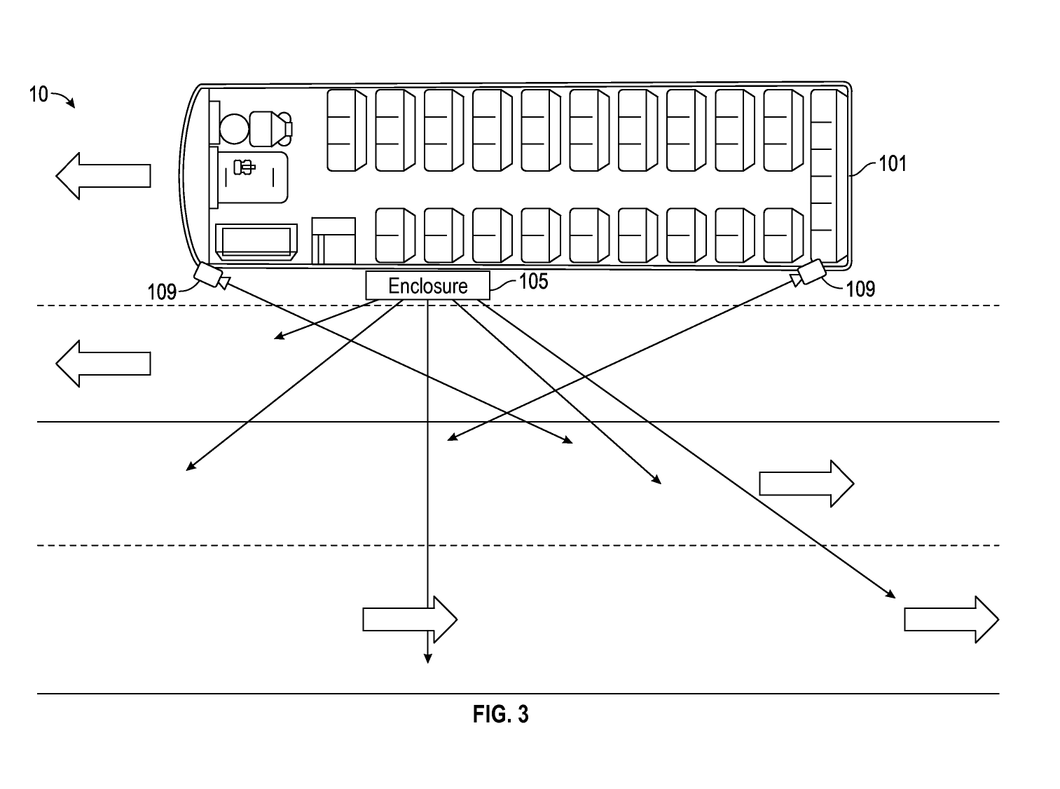

Referring to FIG. 1, a school bus camera system/vehicle monitoring system (10) is shown. FIG. 2 is a side and top view of a school bus (101) with camera system (10). FIG. 3 is a top view of the camera system (10) shown in FIG. 2 with various directional views of cameras on the school bus (101). School bus camera system (10) may be mounted on a school bus (101). System (10) may be connected and transmit data to an administrator center (160). System (10) may include several components mounted on school bus (101). In exemplary embodiments, system (10) includes video monitoring computer (125) and enclosure (105) mounted on school bus (101). Cameras (109) may be mounted in enclosure (105), as well as separately on multiple locations on school bus (101). See, e.g., FIG. 2. Camera (109) may be a trigger camera (110), license plate/lane capture camera (112), and/or any other type of camera (114).

School bus (101) of the present disclosure may take many forms. An example of a school bus (101) is shown in FIGS. 2 and 3. School bus (101) may be a bus specifically designed for student transport, including Type A, B, C, and D buses. Alternatively, school bus (101) may be a van or car used for student transit. Although system (10) is shown in FIGS. 1, 2, and 3 as being implemented on a school bus (101), system (10) may be implemented on any other vehicle and/or transportation system.

School bus (101) may include stopping alerts activated by a school bus driver. Stopping alerts may be at least one of a school bus stopping arm (120) and flashing warning lights activated by the driver. School bus (101) may include a wireless antenna (106) to facilitate communication from the school bus (101) by, e.g., the video monitoring computer (125). In some embodiments, school bus (101) may further include video screen(s) (150), speaker(s) (155), microphones, and/or additional onboard camera(s). Onboard camera(s), speaker(s) (155), and/or microphones may be coupled to a panic button to initiate onboard camera and audio recording and/or notification of any emergencies or other events to appropriate authorities and/or security personnel for a school district. Video screen (150) and/or speaker (155) may permit emergency broadcasting and educational videos to be displayed to school bus passengers. Video screen (150) may be any commercially available LCD monitor. In an exemplary embodiment, video screen (150) may be the Dell™ 23 inch LED-LCD monitor. Speaker (155) may be any commercially available speaker or microphone and speaker assembly.

In a particular embodiment, system (10) may include camera (109) located in enclosure (105) mounted on the side of school bus (101), as well as a camera (109) mounted, for e.g., at termini of bus (101). See, e.g., FIG. 2. Camera (109) may be a trigger camera (110) located in enclosure (105). Trigger camera (110) may be connected to a video monitoring computer (125) located separate from enclosure (105) inside the school bus (101) and may capture a continuous video image set during operation of the school bus (101). Camera (109) may also be a lane capture camera (112) and/or other camera (114) that may also be connected to video monitoring computer (125) and capture additional vehicle information, including license plate, make, model of vehicle, etc. In an alternative embodiment, system (10) may utilize a single camera (109) in enclosure (105) mounted on side of bus (101), and/or at termini of school bus (101) to capture continuous video image set and other vehicle information.

Video monitoring computer (125) may include a processor (130) and a data connection (135). Processor (130) may execute multiples types of software. Software may include video analytics software (138) and video capture software (139). Video analytics software (138) and video capture software (139) may run continuously during operation of system (10). Video capture software (139) may continuously record the continuous image set captured by the trigger camera (110), lane capture camera (112), and/or other cameras (114) during operation of school bus (101). Video capture software (139) may store a copy of the continuous image set from the trigger camera (110) and/or other images from other cameras (112, 114) to local storage (140), e.g. a hard drive, of video monitoring computer (125). In some embodiments, video capture software (139) may also geo-tag the respective images of continuous image set via GPS systems (145).

Once stopping alert, e.g., stopping arm (120) and/or flashing lights of school bus (101), is activated, system (10) may initiate/execute video analytics software (138) via processor (130). Once initiated, video analytics software (138) may then be programmed to interact with video capture software (139) and select a first image subset from the continuous image set. Particularly, video analytics software (138) may be programmed to select all images captured while the stopping alert is activated. Video analytics software (138) may then be programmed to select a reference box/frame (250) from the first image subset. In exemplary embodiments, when software (138) is initially set-up, an outlined area of a video image to monitor may be programmed to define a “trigger region” of the image. This trigger region may typically (but not always) be the rectangular box/frame (250) covering the outlined area of the video image. Reference frame (250) may be user adjustable during installation such that it defines a specific area for an object/vehicle passing through while stopping alert is activated. For example, the location and size of the reference box (250) may be established/adjusted via a settings option in the video analytics software (138) during set-up. In various embodiments, this method may be used for software (138) both during set-up and/or may be done on-site or remotely using the same menu/settings options at a later date after set-up.

In various embodiments, the reference box/frame (250), and area within box (250), may be programmed to recognize/detect a maximum and minimum size of an object/vehicle in that outlined area. Object/vehicle size may be determined by integrating the pixels of the vehicle/object as it passes through the reference box (250). In exemplary embodiments, a capture window size may be setup so that the window encompasses all lanes adjacent to a passing vehicle/object. An image maximum and minimum size may be configured during setup based on the percentage of the size of the object/vehicle in the window. These settings may be easily changed at a later date. Indeed, regardless of the actual resolution in pixels, the settings may be adjusted for any resolution cameras. In embodiments, a triggering event may be provided by reliance on the size and direction of travel of an object passing through a trigger image viewing window. In some embodiments, the object size may be programmed to be at its maximum and coextensive with the reference frame (250), for example, to detect a large truck as it passes through frame (250). Object size may, additionally/alternatively to being area based, be shape based. Video analytics software (138) may therefore be programmed to recognize objects of various dimensions as they cross the reference box (250). In an embodiment, video analytics software (138) may be further programmed to not track elongated narrow objects as they cross the reference frame (250) even if they fall within the maximum and minimum object size. For example, video analytics software (138) may exclude people who walk past the box but include/capture passing vehicles.

In some embodiments, reference frame (250) may be the general background present when the school bus (101) is stopped. In other embodiments, reference frame (250) may take the form of a subsection of the images. The exact shape and dimensions of the frame (250) may be optimized by the video monitoring computer (125), as well as a remote/central server (162) and/or administrator (170) connected to video monitoring computer (125). In embodiments, any amount of administrators (170) may log on to system (10). In exemplary embodiments, adjustments/modifications to system (10) may be performed by administrator (170) via the following steps. Administrator (170) may first directly log on to the system (10) via a remote support software. Administrator (170) may be able to view the entire system (10), and adjust any settings of system (10) as needed. System (10) may be viewed and its settings adjusted via a live wireless connection or wired connections to the system (10). Once initially setup, system (10) and related software operating the system (10) may then be automated.

In embodiments, parameters for various directions of travel of an object/vehicle being monitored may also be defined and programmed into software for system (10). These parameters may initiate the camera trigger for an event described herein. In other embodiments, other parameters may be added if necessary. In exemplary embodiments, the analytics software (138) may be programmed to capture vehicles/objects completely passing left or right through the video image—at which point the video analytics software (138) may confirm a triggering event. In various embodiments, this event confirmation may then be provided as an input to another type of software programmed to look for other event confirmations from items such as stopping alert, including but not limited to activation of stop arm (120) deployment and/or flashing lights. These event confirmations may vary from state to state, city to city, and/or school district to school district. Other type of software may be another form of video analytics software (138), video capture software (139), and/or any other software.

In some embodiments, if the event confirmation provided by video analytics software (138) is the only confirmation received by the other software, the event may be discarded. In alternative embodiments, if the other software receives both the event confirmation provided by video analytics software (138) and the other required event confirmation(s), an event marker may be placed on the recorded video. In embodiments, software designed to look for particular event markers may then then assemble and extract video clips from any available cameras (109) or any other type of camera configurations (109) requested by local authorities. Once the extraction occurs, the video files/clips may then be combined with other information including but not limited to location from the GPS, time and date, direction of travel, accelerometer information, and/or any other information a local entity may legally require. The resulting video clip/file may then be programmed to start a defined number of seconds prior to the triggering event and run to a defined number of seconds after the triggering event. In example embodiments, the defined number of seconds may be five seconds. This clip/file may either remain on a hard drive/local storage in a video monitoring computer (125) on the bus (101) for later removal or be transmitted wirelessly to a designated server (162) or cloud location for review by local authorities.

In some embodiments, once the video clip is on the video monitoring computer (125), it may then be sent to software specifically designed to capture images of, for e.g., license plates, using OCR (Optical Character Recognition) enabled cameras, and then provide the results to a remote administrator. In various embodiments, the software may have a scale of probability of 1 to 5, of which 1 may constitute a good capture with a valid plate number and 5 may constitute a bad capture with the inability to read the plate number. This software may be used to assist the administrator in reviewing more video clips in a shorter time. Systems (10) such as those in the present disclosure may include both automated review of license plates and/or additional review using remote administrators/users.

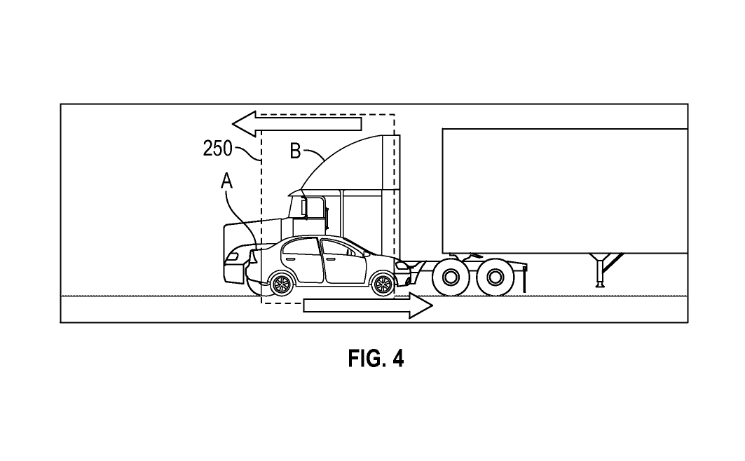

Referring to FIG. 4, an illustration of reference frame (250) of software (138) of a school bus camera system (10) is shown. As shown, the video analytic software (138) detects vehicles A and B as they both pass completely through the defined reference frame/box (250). It also captures additional vehicles if their view is not obstructed by another vehicle. Video analytics software (138) may also be set up to use a reference line/marker or other shape instead of or in addition to the reference box (250). If a reference line is utilized, image subsets may be generated and events triggered/registered when an object/vehicle crosses the line. The size and shape of the reference area or line may be varied depending on a particular application, e.g., a particular bus route that produces recurring false positives.

Once the reference frame (250) is selected by the video analytics software (138), the software (138) may select a second image subset from the first image subset. Second image subset may include all images where the object/vehicle moves completely across the reference box (250). In some instances, when a movement across the reference box (250) is predicted, the video analytics software (138) may flash an LED array (115) to light a portion of a passing object/vehicle. Video analytics software (138) may also compile all images taken by other cameras (109) mounted on bus (101) at the same time as the second image subset. Video analytics software (138) may create an event file with the second subset of images/video clips and identically timed images from the other cameras (109). The event file may include audio, date, time, as well as appended GPS information. Video analytics software (138) may then forward the event file through to video capture software (139) and/or a data connection (135) in conjunction with images from license plate cameras (112) and other cameras taken at the same time as the second subset of images. Video capture software (139) may store the first and second image subsets selected by video analytics software (138). In some embodiments, software (138) may encrypt the event file via known file encryption methods prior to forwarding to ensure the correct recipient views and analyzes the file and corresponding vehicle information.

In various instances, two vehicles may pass through the reference box (250) in an overlapping time frame. In such examples, a third image subset may be selected from the first image subset. Third image subset may be coextensive with the second image subset of a first vehicle. Third image subset may include images where the second vehicle passes completely across the reference frame/box (250). For example, the stop arm (120) may be deployed and image numbers 200 to 1000 may be taken by the camera while the arm (120) is deployed. Image numbers 200 to 1000 may be part of the first image subset set as selected by the video analytics software (138). A first vehicle may pass across the reference frame during image numbers 300 to 400 and therefore be selected by video analytics software (138) into a second image subset. While the first vehicle crosses the reference frame, a second vehicle may also pass through the reference box (250) during image numbers 350 to 450. Image numbers 350 to 450 may include a third image subset. Depending on the number of vehicles passing through the reference box (250), fourth, fifth, sixth and/or greater image subsets may be selected. Each individual image subset may be saved as distinct files in local storage (140) of video monitoring computer (125) and sent as distinct files through the data connection (135).

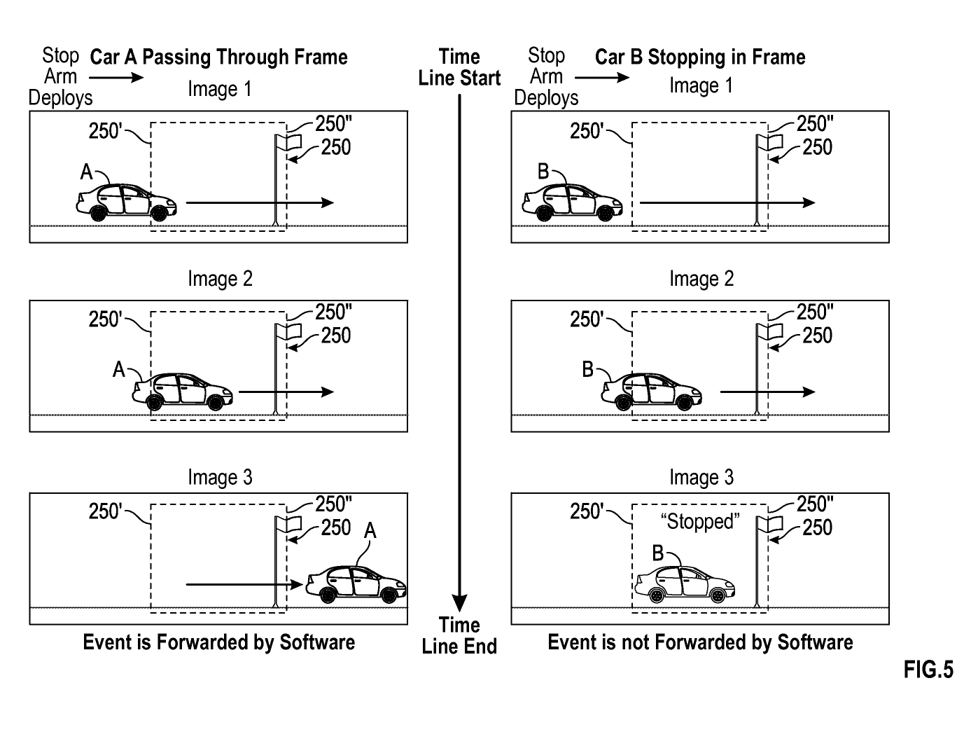

FIG. 5 is a schematic of a school bus camera system (10) described herein implementing software (138, 139). Software includes video analytics software (138) and/or video capture software (139) and is programmed with reference box/frame (250). Reference frame (250) may include a first reference point (250′) and a second reference point (250″) that encapsulates relevant area of a triggering event/passing violation.

In one embodiment, car A may pass first reference point (250′) and move across and past second reference (250″) so as to constitute a triggering event/violation that may then be forwarded for issuance of appropriate citations. A continuous image set of data may be captured by embodiments of camera (109) described herein and stored in video monitoring computer (125) by video capture software (139) as described herein. In exemplary embodiments, school bus (101) may come to a stop to pick up a student/passenger, at which time a school bus stop/stopping arm (120) may deploy and/or flashing warning lights may activate, and camera (109) may initiate a first triggered event. For example, trigger camera (110) may record the continuous image set and software (138) may select a first image subset from the continuous image set. Car A may then move across and past the second reference point (250″) of reference frame (250), thereby causing a second triggered event. As a result of the second triggered event, software (138) of video monitoring computer (125) may select a second image subset including images of the car before and after it passes through the reference frame (250) while the stopping arm is deployed and/or flashing warning lights are activated, e.g., images 1, 2 and 3. Video monitoring computer (125) may be programmed such that it compiles footage from some or all of the different school bus cameras (109) mounted on the school bus as described herein. Second image subset may include camera footage taken for a specified time period before and after the second triggered event took place, e.g., five seconds before and after the triggered event. Second image subset or portions thereof may then be forwarded through the data connection (135) to the administrator center (160) described herein.

In another embodiment, car B may pass first reference point (250′), but stop within reference frame (250) and not move past second reference point (250″) such that a triggered event/violation does not occur. In this embodiment, a continuous image set and first triggered event/first image set may be generated as described herein. However, since car B does not move past the second reference point (250″) of reference frame (250), no second triggered event/second image set is generated, and/or forwarded for issuance of citations.

Embodiments of the present disclosure may therefore provide for numerous advantages over existing systems, including faster and more reliable/accurate methods of capturing specific data/image sets showing relevant passing violations while a school bus or other vehicle is stopped. By focusing on specific video/image sets rather than large and lengthy streams of video/images, the system (10) may thereby obtain more precise information regarding a specific violation, which information may be contained in relatively smaller sized files that may then be easily transmitted, wirelessly or otherwise, to a reviewing party and/or software. Additionally, the smaller sizes of these files may also considerably shorten the reviewing process and/or eliminate it entirely.

Referring back to FIGS. 1, 2, and 3, the second subset of images may be forwarded to an administrator center (160) located distant from the school bus (101) and linked to the onboard camera, video screen (150), speaker and/or microphone (155). See FIG. 1. Administrator (170) and/or software run by a remote/central server (162) at an administrator center (160) may then review the forwarded image subset and issue an appropriate citation. The forwarded image subset/potential violation may be sent to any place/person in any particular city/parish/county. In embodiments, various systems (10) may be setup to operate in any particular configuration as desired by a client. In exemplary embodiments, an administrator may review the forwarded image subsets/video clips prior to being sent to local law enforcement. In some instances, local law enforcement may be part of the process of reviewing the video files/clips forwarded from school bus (101). Once the video clips are reviewed and a determination made that a violation has occurred, a citation may be issued by the local governing authority. Embodiments of the present disclosure thereby provide for methods and systems that automatically determine what constitutes a potential violation, create a file with this information, and transfer that file to a designated server for review.

Administrator center (160) may be connected to video monitoring computer (125) via a wireless network/cellular connections. Examples of networks include the GSM network of AT&T™ or the CDMA network of Verizon™. Administrator center (160) may include storage to record data received and, in some instances, remotely access storage (140) of a video monitoring computer (125) to view images not automatically forwarded. In some embodiments, the reference box/frame (250) of the video analytics software (138) may be adjusted remotely from the administrator center (160).

Administrator center (160) may include a central/remote server (162). Central server (162) may be physical or web based (e.g. Amazon Web Services). Server (162) may be a commercially available server, e.g. an IBM System×M5 Tower servers. In exemplary embodiments, server (162) may be an internet-based server located in the cloud. Central server (162) may be adapted to execute any operating system including Linux™, UNIX™, Windows™, or any other suitable operating system. Central/remote server (162) may run software (172). Software (172) may interface with various systems accessible by the video monitoring computer (125) (e.g. VOIP, GPS, remote video viewing, remote adjustment of cameras, vehicle diagnostics). In some embodiments, software (172) may directly receive video images/file from the video monitoring computer (125) and issue citations. As described herein, in some embodiments, system (10) may identify a triggering event and identity a passing violation. A video clip of the violation, as well as other information of a vehicle/object (including but not limited to OCR processed data related to vehicle information such as license plate information), may be compressed into a secure encrypted container file which may then be sent to the central server (162). In various embodiments, software (172) may extract OCR processed data and create a violation file showing particular images of the violation, including but not limited to time and/or date, vehicle license plate information, vehicle owner and address information, violation location, direction of travel, and/or any other information a governing entity would like to have packaged with this data. In example embodiments, information such as the vehicle owner and address information may be received from an automated search of a master database to find a match between the violating vehicle and related owner information. In embodiments, the violation file may then result in automatic generation of a printed ticket with, for e.g., a URL link to the actual files of the violation, including a video of the violation.

Administrator center (160) may also include a user interface (165) staffed by an administrator (170). Administrator (170) may be licensed by an appropriate law enforcement authority to issue citations. Administrator (170) may monitor the second subset of images showing illegal passing violations at the user interface (165) and issue citations on the basis thereof. Administrator (170) may also broadcast video and voice messages to the bus via the school bus video screen (150) and speaker (155) (e.g. via VOIP). Administrator (170) may also have the ability to remotely monitor a video and audio feed if desired. In some embodiments, administrator (170) may interface with the central/remote server (162) and server software (172), potentially altering the settings thereof, via the user interface (165).

Camera (109) of the present disclosure may be any suitable image capturing device. For example, camera (109) may be an analog, digital, or IP video camera using for instance, charge-coupled device (CCD) technology. Camera (109) may have normal or HD resolution and be capable of recording at least 5 to 30 frames per second. In various instances, camera (109) may be configured to operate in the infrared (IR) spectrum with the use of internal or external IR illuminators. Camera (109) may be equipped with a telephoto, wide angle, standard, or manual or motorized zoom lens. In some embodiments, the camera (109) may be remotely moveable in multiple directions for optimal camera positioning. Camera (109) may also be zoomed and focused remotely. Camera (109) may be configured to capture a portion of the deployed school bus stopping arm (120) and of any moving vehicle that passes the school bus (101) while the school bus stopping arm (120) is deployed and/or flashing lights are activated.

Camera (109) of the present disclosure may take a variety of different configurations. System (10) may include single or multiple cameras (110, 112, 114) at a central point on the side of the bus (101) in an enclosure (105). In some embodiments, the system (10) may include multiple cameras (109) at other points on the bus. As shown in FIGS. 2 and 3, system (10) may further include cameras (109) at the termini of the bus (101). Cameras (109) may offer a bird's eye wide-angle perspective. See, e.g., FIG. 3. A first camera (109) may be placed at the front termini of the bus (101) facing rearward and a second camera (109) placed at the rear termini of the bus (101) facing forward. Frontward and rearward facing cameras (109) may be optimized to image different traffic lanes near the school bus (101). Frontward and rearward facing cameras (109) may be lane capture cameras (112) or any other cameras (110, 114). In an example embodiment, cameras (109) at termini of bus may face at a 90° angle/field of view with respect to the bus (101) and may be configured to generate the continuous image set described herein.

Embodiments of the present disclosure provide for multiple cameras (109), including trigger camera (110) to provide a trigger to an event, for e.g., a passing vehicle, and other cameras (109), including lane capture cameras (112) and/or other cameras (114) to potentially capture the event from a wide-angle perspective, as well as focus on other lanes of traffic (both in the same and opposite direction of travel as the vehicle) in order to capture video segments/image subsets at the time of trigger. These image subsets may therefore come from multiple cameras (109) and may be used to capture relevant vehicle information. In embodiments, lane capture camera (112) may capture images of vehicles on multilane roads. For example, lane capture camera (112) such as the may capture images of vehicles on up to an 8 lane road. In example embodiments, trigger camera (analytic camera channel) (110) may notify a video capture software (139) of a triggering event, which may then capture all the video from trigger camera (110), lane capture camera (112) and/or other cameras (114). Trigger camera (110), lane capture camera (112), and/or any other cameras (114) used in system (10) may be any commercially known camera with the capabilities described herein.

In alternative embodiments, the functions performed by multiple cameras (109) described herein may be performed be a single camera (109) with superior image resolution capabilities. In an example embodiment, camera (109) may be a zoom camera with up to 700 lines of resolution. However, camera (109) may be any type of camera with the capabilities described herein. Single camera (109) may be located in enclosure (105) mounted to side of school bus (101) and/or at any other location of school bus (101) such that it can capture images of vehicles passing bus (101). In exemplary embodiments, this camera (109) with superior image resolution (including potentially two to three additional cameras) may be used to cover a 180° field of view on a stop arm (120) side of a bus (101) and capture high resolution video images. These high resolution video images may then be processed by segmenting areas of the images, each for a separate purpose. Particularly, the center area/reference frame (250) of each video image may be isolated for detecting and analyzing whether the movement of an object/vehicle in that area qualifies as an event. In some embodiments, the areas to the left and right of the reference frame (250) may be isolated and used for capturing the vehicle's license plate, color, make, model, etc.

Embodiments of the present disclosure may not only capture video images of a vehicle and license plate, but may also internally analyze those images and automatically determine the license plate number, state, expiration date, color, make, model, and year of the vehicle as described herein. Video analytics software (138) may then package this information in a file and export the file to an appropriate server (162) along with the other information, including but not limited to: 1) multiple video clips of the event, including the trigger image and multiple camera angles of the event; 2) GPS information; 3) audio recording during the event; 4) vehicle diagnostics and status; 5) speed, heading, and rate of acceleration of the vehicle; and/or 6) any other information that may be obtained by software (138) via connections to embodiments of camera (109), video monitoring computer (125) and/or other components of video monitoring computer (125), including but not limited to vehicle diagnostics and sensors connected to GPS (145) and accelerometers.

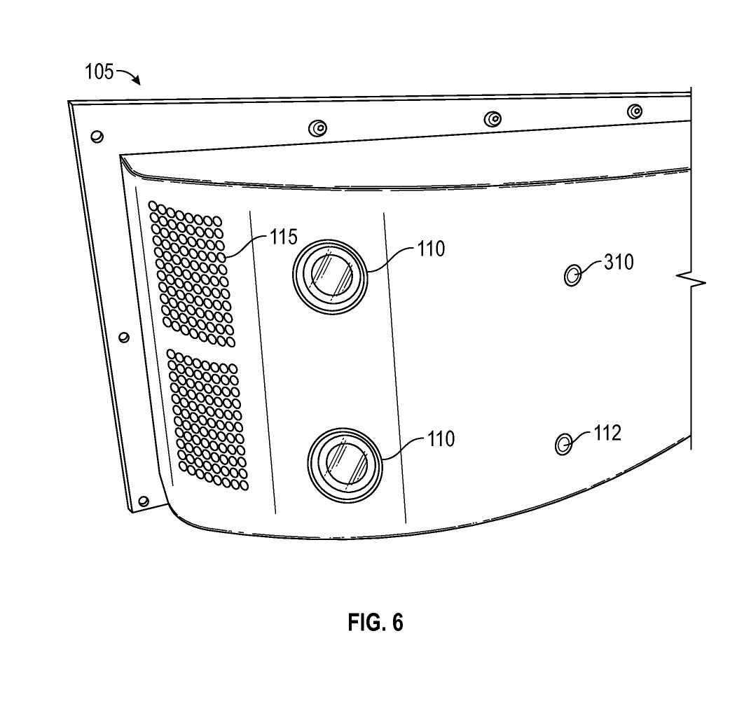

Referring to FIG. 6, a front view of an enclosure (105) for a school bus camera system (10) is shown. Enclosure (105) may be made from metal, plastic and/or other materials. Enclosure (105) may include single or multiple cameras (109). Enclosure (105) may include an externally visible sensor (310) that may change colors when moisture is present inside the enclosure (105). Enclosure (105) and fittings may be weather and waterproof, such that enclosure (105) may withstand pressure washing and maintain a dry electronics environment.

Enclosure (105) may further include a trigger camera (110) and/or other lane capture cameras (112). See, e.g., FIG. 6. As shown, enclosure (105) includes two trigger cameras (110) and one lane capture camera (112). Enclosure (105) may further include an LED array (115) for lighting a portion of a vehicle passing the school bus (101) and/or for heating the enclosure (105). An exemplary LED array is shown in FIG. 6. LED array (115) may include four 4×10 diode panels. LED array (115) may provide continuous/flash illumination at day break, dusk or night. LED array (115) may be turned on or a flash may be triggered by a video monitoring computer (125) and/or a motion sensor. In various embodiments, the LED array (115) may include IR LEDs. The IR LED array (115) may provide illumination so video can be captured in lowlight situations during early morning and late evening. The light of an IR LED array (115) may or may not be visible and may go unnoticed by drivers and bus passengers. In exemplary embodiments, IR LEDs may include gallium arsenide or aluminum gallium arsenide.

Enclosure (105) may include anti-condensation systems. For example, the enclosure (105) may be coated with an anti-fog coating. Enclosure (105) itself may be completely sealed and supplemented with getter material to absorb remaining/leaked in water vapor. Enclosure (105) may also use transparent/non-transparent heating coils or transparent/non-transparent heating films to evaporate water off of the surface of enclosure (105).

Components of the enclosure (105) may be powered by a power source/power supply (175). Power supply (175) may be located within video monitoring computer (125) described herein and hard-wired to the enclosure (105). Power source (175) may be a battery or may be linked to power system of a school bus (101) described herein. Power source (175) may include dual power filtering for voltage and EMI to provide enclosure (105) components with power regardless of fluctuations in the power system for bus (101).

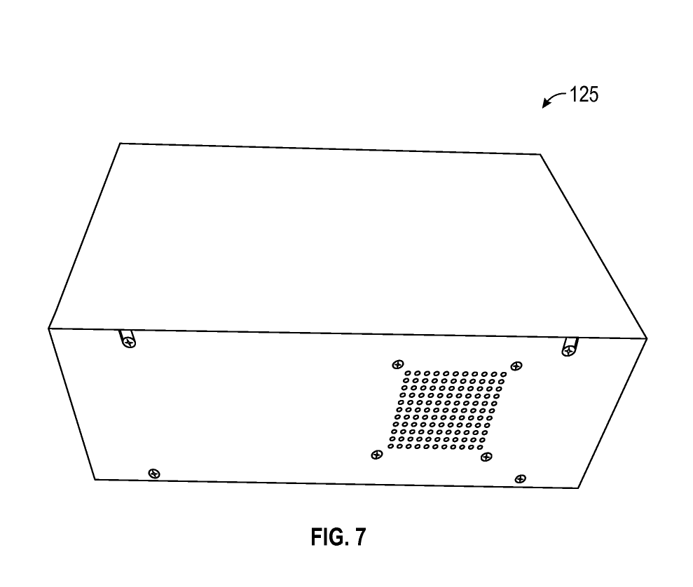

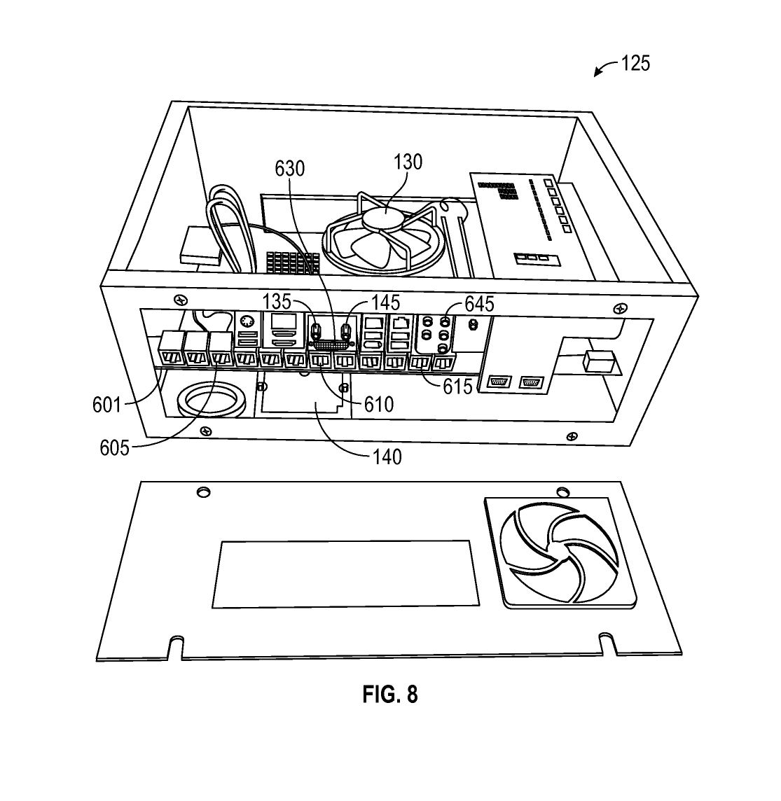

Components of enclosure (105) may be linked to video monitoring computer (125) described herein. Referring to FIG. 7, an isometric view of a video monitoring computer (125) is shown. FIG. 8 is an isometric view of an interior of the video monitoring computer (125). In an exemplary embodiment, video monitoring computer (125) may be located under a driver's side student bench seat, which seat may be located approximately in the center of the bus (101). Computer (125) of the camera system (10) may encompass any suitable processing device. Computer (125) may be adapted to execute any operating system including Linux™, UNIX™, Windows™, or any other suitable operating system. Computer (125) may be implemented by a processor (130) running software (138, 139) connected to memory and storage (140). Processor (130) may execute instructions, thereby communicating and processing data from embodiments of camera (109) and sending the data to, for e.g., administrator center (160) via data connection (135). Although described as a single processor, multiple processors may be used according to particular needs. References to processor are meant to include multiple processors where applicable. Memory and storage may include any memory or database module and may take the form of volatile or non-volatile memory including, without limitation, magnetic media, optical media, random access memory (RAM), read-only memory (ROM), removable media, or any other suitable local or remote memory component. Data connection (135) of the tracking system computer (125) to the administrator center (160), remote server (162), and/or administrator (170) may be via the internet, internet subnetworks, such as a VPN, or via a proprietary network. Data connection (135) may be may be hardwired to the processor (130) or computer (125), for example via cat 5 into a network card, or it may be wireless, for example via GSM, satellite, or WiFi. In some embodiments, data connection (135) may be attached to antenna (106) mounted on school bus (101). See, e.g., FIG. 2.

Video monitoring computer (125) may include storage (140). Storage (140) may include any drive, memory or database module and may take the form of volatile or non-volatile memory including, without limitation, magnetic media, optical media, random access memory (RAM), read-only memory (ROM), removable media, or any other suitable local or remote memory component. In exemplary embodiments, storage (140) may be a 1TB Seagate™ hard drive. Depending on particular application needs, the video monitoring computer (125) may include both a primary and secondary storage device.

As shown, video monitoring computer (125) is connected to multiple cameras (109) via multiple camera inputs (601, 605, 610, 615). In an exemplary embodiment, the connection between the video monitoring computer (125) and camera(s) (109) may be via a color coded cat 5 cable to permit easier installation and maintenance. A video capture card may be used to gather information from cameras (601, 605, 610, 615) and/or other cameras (109) mounted on school bus (101), and communicate this information to video monitoring computer (125). Alternatively, the connection between video monitoring computer (125) and camera(s) (109) may be wireless.

In exemplary embodiments, video monitoring computer (125) may include a processor (130), a video capture card, one of more hard drives, a data connection (135), storage (140), GPS (145), a video connection (630), and a speaker connection (645). All these components may be connected to the processor (130). Video monitoring computer (125) may be configured to connect to video screen (150), speaker (155), and/or microphone described herein through the video connection (630) and speaker/microphone connection (645). In some embodiments, mobile hardened hardware may be used. Off-the-shelf hardware designed for desktop and/or server uses may be utilized that passes stringent mobile environment tests.

GPS (145) of video monitoring computer (125) may be connected to a variety of systems including but not limited to the Global Positioning System, the Global Navigation Satellite System (“GLONASS”), and/or the BeiDou Navigation Satellite System. GPS (145) may receive information concerning the latitudinal and longitudinal position of the school bus (101). In exemplary embodiments, the GPS (145) may be connected to antenna (106) mounted to exterior of school bus (101).

Video monitoring computer (125) may also include a variety of other sensors, including but not limited to accelerometer, engine, fuel, fuse, and/or temperature sensors. Video monitoring computer (125) may also include sensors to determine whether braking and flashing lights of the bus (101) are properly functioning. The sensors may be connected to the processor (130) and configured to be accessible via the data connection (135) by an administrator (170). In some embodiments, these sensors may be part of the bus (101) and accessible to the video monitoring computer (125).

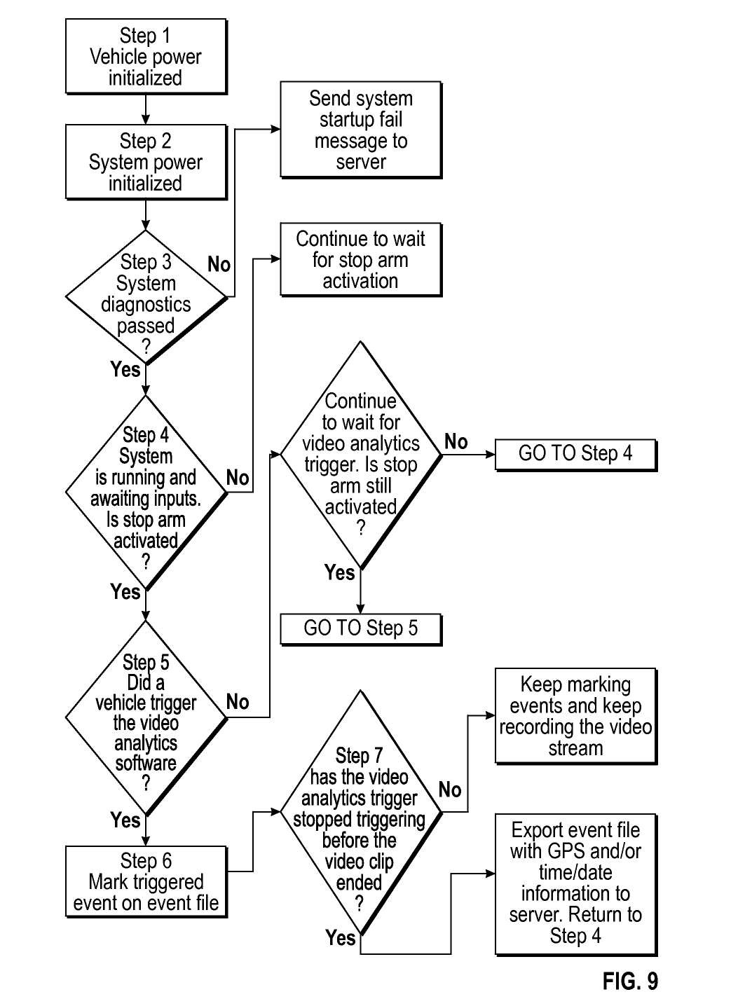

FIG. 9 is a flowchart showing a school bus camera system (10) described herein. Particularly, FIG. 9 shows the interaction of school bus (101), video monitoring computer (125), software (138, 139), and/or central server (162) described herein. School bus camera system (10) described in FIG. 9 may be implemented using the apparatuses, systems and methods described herein, including various embodiments thereof. School bus camera system (10) may include the following steps.

Vehicle/school bus (101) power may first be initialized. Camera system (10) power may then be initialized. System (10) may run initial diagnostics via video monitoring computer (125). If system (10) fails the initial diagnostics, system (10) may send a startup fail message to server (162). If system (10) passes the initial diagnostics, system (10) may then wait for school bus (101) to come to a stop and stopping arm (120) to deploy and/or flashing warning lights to activate. Once stopping arm (120) and/or flashing lights are deployed/activated, system (10) may then wait for initiation of a triggered event. Particularly, system (10) may wait for a vehicle to pass bus (101), thereby causing a triggered event and triggering the video analytics software (138). In exemplary embodiments, system (10) may include a first triggered event including a continuous image set and first image set selected from the continuous image set, and/or a second triggered event including a second image set selected from the first image set as described herein. Once triggered, software (138) may mark the triggered event on a video clip/event file and may include footage taken five seconds before and after the triggered event. Event file may be tagged with GPS data, date and time, etc. In some embodiments, system (10) may continue marking events and recording video streams until system (10) and/or software (138) stops triggering.

Event file/video clip may then be forwarded/exported through the data connection (135) to the administrator center (160) described herein. Particularly, event file/video clip/second image subset may be exported to server (162) in administrator center (160) for further analysis. Once exported, stop arm (120) may de-activate or remain activated if vehicles are still driving past bus (101). In some embodiments, a copy of the event file may be stored locally in the video monitoring computer storage (140). In various embodiments, event file/video clip/second image subset may be further analyzed, prior to forwarding through the data connection (135), to eliminate any potential false positive results and/or reduce the file size such that it only shows information necessary for issuance of a citation.

While the embodiments are described with reference to various implementations and exploitations, it will be understood that these embodiments are illustrative and that the scope of the disclosures is not limited to them. Many variations, modifications, additions, and improvements are possible. Further still, any steps described herein may be carried out in any desired order, and any desired steps may be added or deleted.

What is claimed is:

1. A school bus camera system, comprising:
at least one camera and a video monitoring computer mounted on a school bus, the video monitoring computer including a processor and a data connection,
wherein the at least one camera captures a continuous image set, and
wherein the processor is connected to the at least one camera and executes software that: selects a first image subset from the continuous image set, the first image subset including images captured while a stopping alert is activated; selects a reference frame from the first image subset; selects a second image subset from the first image subset, the second image subset including images where an object moves completely across the reference frame; and transmits the second image subset through the data connection.

2. The system of claim 1, wherein the stopping alert is at least one of a visual signal and audio signal.

3. The system of claim 2, wherein the visual signal is at least one of a school bus stopping arm and flashing lights.

4. The system of claim 1, further comprising an administrator center connected to the video monitoring computer through the data connection, the administrator center including a server that receives the second image subset from the data connection.

5. The system of claim 4, wherein the administrator center includes a user interface that displays the second image subset to an administrator.

6. The system of claim 4, wherein the server includes a server processor that executes software that reviews images from the second image subset and issues appropriate citations.

7. The system of claim 1, further comprising at least one of a monitor, microphone and speaker that is connected to the processor and remotely accessible to an administrator.

8. The system of claim 1, wherein the video monitoring computer includes a storage apparatus connected to the processor, the processor executing software that records the continuous image set to a first file on the storage apparatus.

9. The system of claim 8, wherein the video monitoring computer includes a second file in the storage apparatus connected to the processor, the processor executing software that records the second image subset to the second file on the storage apparatus.

10. The system of claim 5, further comprising at least one sensor connected to at least one of a GPS, accelerometer, engine, fuel, fuse, brake light, and flashing lights, the at least one sensor in communication with the video monitoring computer, which video monitoring computer communicates information from the at least one sensor to the administrator.

11. The system of claim 1, wherein the reference frame is user adjustable during installation such that it defines a specific area for the object passing through while the stopping alert is activated.

12. The system of claim 11, wherein the reference frame is programmed to recognize a maximum and minimum object size.

13. The system of claim 12, wherein the object size is determined by integrating the pixels of the object as it passes through the reference box.

14. The system of claim 1, wherein the at least one camera has a 90 degree angle field of view relative to the path of the school bus.

15. The system of claim 1, wherein the at least one camera has a 180 degree angle field of view relative to the path of the school bus.

16. The system of claim 1, further comprising at least two lane capture cameras, a first lane capture camera facing forward and a second lane capture camera facing rearward.

17. The system of claim 1, further comprising at least two wide angle cameras offering bird's eye views, a first wide angle camera located at the front termini of the school bus and a second wide angle camera located at the rear termini of the school bus.

18. The system of claim 16, wherein the timing of images taken from the first and second lane capture cameras correspond to the timing of images taken for the second image subset.

19. The system of claim 18, wherein the images taken from the first and second lane capture cameras are forwarded through the data connection along with the second image subset.

20. A method of capturing and sending object information, comprising:
selecting a first image subset from a continuous image set generated by at least one camera mounted on a vehicle, the first image subset including images captured while an alert is activated;
selecting a reference frame from the first image subset; and
selecting a second image subset from the first image subset, the second image subset including images where an object moves completely across the reference frame.

21. The method of claim 20, wherein the alert is at least one of a visual signal and audio signal.

22. The method of claim 20, wherein the visual signal is at least one of a school bus stopping arm and flashing lights.

23. The method of claim 20, further comprising sending the second image subset to an administrator center through a data connection in a video monitoring computer mounted on the school bus, the administrator center including a server that receives the second image subset from the data connection.

24. The method of claim 23, wherein the server includes a server processor that executes software that reviews images from the second image subset and issues appropriate citations.

25. The method of claim 20, wherein the reference frame is user adjustable during installation such that it defines a specific area for the object passing through while the alert is activated.

26. A vehicle monitoring system, comprising:
an image capture arrangement in communication with a monitoring computer, the monitoring computer including video capture software and video analytics software;
wherein the video capture software records a continuous image set captured by the image capture arrangement,
wherein the video analytics software: selects a first image subset from the continuous image set, the first image subset including images captured while a stopping alert is activated; selects a reference frame from the first image subset; and selects a second image subset from the first image subset, the second image subset including images where an object moves completely across the reference frame.

27. The system of claim 26, wherein the image capture arrangement is a single camera.

28. The system of claim 26, wherein the image capture arrangement is a multi-camera arrangement.

29. The system of claim 26, wherein the video analytics software transmits the second image subset to an administrator center through a data connection, the administrator center including a server that receives the second image subset from the data connection.

30. The system of claim 29, wherein the server includes a server processor that executes software that reviews images from the second image subset and issues appropriate citations.

31. The system of claim 26, wherein the reference frame is user adjustable during installation such that it defines a specific area for the object passing through while the alert is activated.
